(19) United States
(12) Patent Application Publication
(10) Pub. No.: US 2014/0260839 A1
(43) Pub. Date: Sep. 18, 2014

(54) Powered grounds tool supporting handle

(71) Applicant: Edward Patrick Hurley, Sarasota, FL (US)

(72) Inventor: Edward Patrick Hurley, Sarasota, FL (US)

(21) Appl. No.: 13/815,593

(22) Filed: Mar. 12, 2013

(51) Int. Cl. B25F 5/02

(52) U.S. Cl. CPC B25F 5/02
USPC 81/489

(57) ABSTRACT

This grounds tool supporting handle mounts at an upper end portion of a support and an implement mounted at a use end of the support. Each such handle includes a ball joint largely retained in a ball socket closure for making multiple adjustments of the handle beside the powered grounds tool support longitudinal axis, while simultaneously making sufficient height adjustments to the implement in relation to the grounds surface. Optionally, this handle may be equipped with improved damping mechanisms and or tool adjusted when the powered grounds tool demands a stationary mode of operation.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of grounds equipment and more specifically to a powered grounds tool supporting handle.

Various hand-held rotary powered grounds tools, e.g., grass trimmers, stick edgers, sweeper/vacs, etc., are generally demanded where mowers cannot reach, such as along paths, fences, curbs, fences, trees, garden beds, walls, decks, steps, doorways, etc. Each such grounds device generally includes an elongated support including a power control handle mounted at an upper end portion of the support and a percussion work implement, e.g., string head, knife, fan, etc., mounted at a use end of the support. To provide two-handed tool balance, a forward or side guide type handle is also mounted at the upper end portion of the support. A drive assembly including a dedicated gas/electric motor is mounted in the support and coupled to the work implement to communicate with a trigger located proximate the power control handle for performing each desired grounds operation.

The string trimmer characterization of the device has become popular for the versatility of its rotary string implement, e.g., small diameter automatic feed string, moderate diameter bump & feed string, large diameter fixed string, etc. The underside of the string trimmer power control handle is often longitudinally grasped with three fingers, while at the same time an adjoining index finger engages the trigger and the guide handle is laterally grasped ahead on the support to advance the string implement in a lateral profile near the ground surface during the string trimming operation. Alternatively, the string trimmer handles can be hand adjusted time and again and grasped in one of a plurality of contortions to advance the string implement in a vertical profile along a grounds border during the string edging operation.

The blade edger characterization of the device generally has the underside of the power control handle longitudinally grasped by three fingers, while at the same time an adjoining index finger engages the trigger and the guide handle is laterally grasped ahead on the support to advance a rotary knife implement into a grounds border during the blade edging operation. Because the blade edger implement could kickback at the user when forced sideways, the brush-cutter characterization of the device often has a U-shaped bike handle assembly telescopically grasped on the support to separate the user from a large diameter string or saw blade implement during the brush cutting operation.

The air sweeper/vac characterization of the device is often used as a turnaround step of the blade edger device because the underside of the power control handle is longitudinally grasped by three fingers, while at the same time an adjoining index finger engages the trigger to advance a fan and pipe/nozzle implement at loose debris to move the loose debris into the yard during the grounds cleanup operation. The grounds cleanup operation sweeps detached vegetation away from walks mold use as a food source, to thereby shorten the grounds cleanup cycle because power-washing is lessened on mold stained walks. The hand-held air sweeper/vac unit may also be used in the yard to vac up leaves, which often reduces plant disease.

A problem persists with powered grounds tools, however, in that frequently the versatile string trimmer string implement tends to bottom-out and jump when meeting grounds resistance concerning hard objects, e.g., gravel, curbs, sidewalks, etc. Meanwhile, the blade edger knife unit is apt to intermittently jump or kickback sideways when soil is dry and there is little or no vegetation growth because tree roots will rise and so will soil when the edger unit is driven into the grounds margin. This problem encourages one hand to pull the guide handle away from the grounds chatter, while at the same time the other hand, if supportive, pushes the other handle toward the grounds chatter. This push-pull force among the hand-handle interface will continue until each hand reaches a peak gripping force on each respected handle, which is exacerbated when the air sweeper advances with three fingers grasping the underside of the air sweeper/vac power control handle following the edger advancement with three fingers grasping the underside of the edger power control handle.

When there is an impulse to grasp each powered grounds tool supporting handle in an unorthodox tight manner, considerable force energy is amplified across the user's stiffened anatomical structures to cancel out among fluidic joints and neurological pathways, which has an exponential effect on the user's health impairment recovery rate.

In an attempt to improve tool use guidelines, several prior US patents have been disclosed pertaining to powered grounds tool supporting handles. Some of these handles include U.S. Pat. Nos. 6,076,231, 6,439,088, 6,581,246, 6,701,623, D 669,326 S, 6,515,598 B1, 6,701,623, 7,266,893 B1 and 2007/0,068,008 A1.

U.S. Pat. No. 6,439,088 generally discloses a multi-grip handle for a powered grounds tool having a first grip and a second grip mounted at an upper end portion of a support by a coupling mechanism and a trimmer rotatably mounted at a lower use end of the support. The first grip is used to support the trimmer during the trimming operation and the second grip is used to support the trimmer during the edging operation. This multi-grip arrangement requires the support to be held at a forty-five degree angle, which often leaves height challenged users in disarray. In fact, using the second grip poses a safety risk because the unit implement is put in an upside down sideward use position, which exposes the implement to the user and forces the user to look away from what lies ahead. The multi-grip combination further requires about double the composite material, and a high cost relative to ordinary powered grounds tool support handles.

U.S. Pat. No. 6,581,246 discloses an adjustable handle mounted at an upper end portion of a support to control a grass trimmer at a lower use end of the support. The adjustable handle generally includes a handgrip, a rod bolt, a through bolt and a two piece clamp. The adjustable handle parts are assembled to leave about ten degrees of slack on the support during the operation. Essentially, the adjustable handle is time consuming and difficult to adjust with one hand while the tool unit is held up with the other hand to accurately set the grass trimmer in a predetermined operating position. Consequently, the adjustable handle is ineffective during the string edging operation primarily because the adjustable handle lateral slack mostly dampens lateral reactive forces transmitted from the string unit use end. Such damping mechanisms are impractical when laterally worn on string trimmer handles because a mowed yard will mostly absorb the string trimmer lateral reactionary forces and even cushion the user's lateral footing. And yet, when the adjustable handle is used during the less forgiving string or blade edging operations, the damping mechanisms have little or no damping capability whatsoever.

U.S. Design Pat. 669,326 S shows an adjustable handle assembly having a base portion mounted to an outer side of a ball socket, in connection with an inner side of the ball socket mounting to a large portion of a ball joint and locking together with a locking mechanism, and in connection with the ball joint mounting over the support longitudinal axis for guiding a string implement at a lower use end of the support. In this case, the string implement will disadvantagely bottom-out during the operation, due to the string outer tip rarely lining up with the ground surface when the adjustable handle is rotated side-to-side about the support longitudinal axis. Of course, the adjustable handle design can be adjusted side-to-side and front-to back to avoid string bottom-out; however, the effort is complicated and could lead to hand extension stress. The adjustable handle design is costly to manufacture because the locking mechanism is incompatible with stationary supporting handles, which generally are tool adjusted on the support.

U.S. Pat. No. 6,076,231 discloses a blower including at least one handle for supporting a fan and pipe/nozzle implement. The blower supporting handle cannot adjust sideways for advancing the nozzle in a vertical profile, which permits debris to become airborne in stagnant confined spaces.

U.S. Pat. No. 6,516,598 B1 discloses a wheelbarrow cutting device including a power control handle adjacent to a throttle control and a side handle mounted at a back end of a support to support a knife implement mounted at a lower anterior use end of the support. A gas/electric motor is mounted in the support which could disadvantagely exhaust toward the user's breathing passages, such as when a gas motor idles or runs at high speed. The knife could inadvertently tilt sideward or forward to either cause ground-tool chatter or tool kickback. Indeed, the power control handle underside is supported by three fingers a remote distance away from the knife implement, which encourages tool imbalance.

U.S. Pat. No. 6,701,623 discloses a central support member having a work element mounted at a lower end of the central support member and an adjustment clamp to mount a single prong handle at the upper end portion of the central support member. The single prong handle will generally adjust from a stowed position to an operating position. However, when the tool unit is held up with one hand, it is difficult for the other hand to loosen the clamp to rotate the handgrip sideways for use. Consequently, the single prong handle can inadvertently slip out of the clamp and release from the central support member, due to gravitational force. Persons with disabilities often find it difficult to loosen and tighten threaded clamps and may prefer an alternative tool adjustable handle instead for safekeeping. The single prong handle has to be detached from the support for its alternate left and right handed use on the support. The tool will impart vibration toward the single prong handle distal end.

U.S. Pat. No. 7,266,893 B1 discloses a string trimmer having multiple grips and multiple triggers at an upper end portion of a support to support a trimmer head at a use end of the support. The impact of multiple triggers and handgrips takes its toll when adding tool load and considering manufacturing costs.

US 2007/0068008 A1 discloses a hand-held power tool including at least one adjustable handle pivotally mounted at an upper end portion of an elongated support and an adjustable grass trimmer head pivotally mounted at a use end of the support for use. These remote adjustment locations are lumbering, time consuming and potentially dangerous, especially when the tool implement becomes exposed to the user when pivoting front to back on the support, whereby hidden grounds material, e.g., gravel, thorny mulch, dirt, etc., can easily fling at the user.

US 2011/0289721 A1 discloses a hand-held leaf blower supporting handle of a lever type having a prong end portion mounted to the back end portion of a support housing to support a motorized fan and pipe/nozzle implement which is used to force airflow out at the nozzle. The leaf blower also includes a donut damping mechanism for damping vertical machine vibration and a pair of spring damping mechanisms for damping lateral vibration where the lever handle and the housing support meet. In practice, the leaf blower pipe/nozzle has a mechanical advantage to impart reactive forces toward the lever handle free end, while at the same time the donut damping mechanism compresses at its back end and decompresses at its front end for compounding handle vibration. This cantilevered leaf blower will only compound handle vibration when it is used in conjunction with the other aforementioned tools.

None of the above inventions and patents, taken either individually or in combination, is distinguishable to the immediate invention as claimed. Essentially, the existing grounds tool handles present a challenge because they require gratuitous or restrictive adjustment, they come apart easily, they load the operation with excess parts/material and they are the main source of grounds-tool chatter, amplified handle vibration, tool wear, user stress, etc.

### BRIEF SUMMARY OF THE INVENTION

In view of the foregoing, it is, indeed, a principle object of the present invention to provide a universally accepted powered grounds tool supporting handle configured to make sufficient height adjustments beside the support longitudinal axis, while simultaneously making sufficient height adjustments to the tool implement for avoiding the disadvantageous characteristics of prolonged static postures and pressures of the prior art.

Another object of the invention is to provide the grounds tool supporting handle adequate enough adjustment for maintaining the powered grounds tool implement in an anterior operational position ahead of the user, so as to maintain visibility on what lies ahead.

Yet another object of the invention is to provide the powered grounds tool supporting handle tool adjustment when the powered grounds tool demands a fixed mode of operation, which increases safety standards while reducing manufacturing costs.

A further object of the invention is, but it is not essential, to provide the powered grounds tool supporting handle handgrip a plurality of wavy cushion strips intermittent to a plurality of wavy support strips, so as to cancel out machine vibration, while at the same time strengthen the unit handle at each support strip.

Yet a further object of the invention is, but it is not essential, to provide the powered grounds tool supporting handle a plurality of spikes among a plurality of dimples about the ball joint and ball socket interactive matrix, so as to provide friction during the unit handle adjustment and to absorb vibration at the ball assembly interface.

Other objects and advantages of the present invention will become apparent from the following descriptions, taken in connection with the accompanying drawings, wherein, by way of illustration and example, an embodiment of the present invention is disclosed.

Briefly, in accordance with a preferred embodiment of the present invention, a powered grounds tool supporting handle comprises a main handle and a front or side handle mounted at an upper end portion of the support. A drive assembly including a dedicated gas/electric motor is mounted in the support to operably drive an implement (e.g., string head, edger blade, fan, etc.) toward a use end of the drive assembly. The drive assembly also includes a trigger arranged in a pistol grip configuration on the main handle to communicate with the motor, in which the trigger is selectively activated for performing each desired grounds operation. Damping mechanisms can be added to these grounds tools for decreasing handle vibration.

Each handle includes an upstanding handgrip at one end and a ball joint at its other end. A ball socket closure is sized at one end to mount to the ball joint at a convex side and sized at the other end to mount to the support. Preferably, the ball socket is forming a plurality of dimples on its outer surface to interact with a plurality of dimples formed on the ball joint inner surface, which aids in holding each upstanding handle in place. The ball socket closure may have a releasable lock which is closed for locking each handle tightly to the support and opened to permit multiple degree of freedom adjustments of each handle beside the support longitudinal axis, e.g., up to thirty degrees clockwise-to-counterclockwise adjustment, up to sixty degrees front-to-back adjustment and up to two-hundred forty degrees side-to-side adjustment all in one sequential hand movement.

In practice, the left or side handle is grasped in a predetermined tall use profile in relation to the support profile while the main handle is grasped and the adjoining index finger engages the trigger, and while the implement is simultaneously advanced in a sufficient low lateral operational direction in relation to the grounds surface. The left or side handle can also be grasped in a predetermined low use profile in relation to the support profile while the main handle is grasped and the adjoining thumb engages the trigger, and while the implement is simultaneously advanced in a sufficient tall vertical operational direction in relation to the grounds surface.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a partial exploded view of a powered grounds tool illustrating a supporting handle described herein;

FIG. 2 is a partial front view of a powered grounds tool illustrating the supporting handle in a low profile;

FIG. 3a is a partial side view of a powered grounds tool illustrating a trigger for index finger engagement;

FIG. 3b is a view of FIG. 3a illustrating the trigger for thumb engagement;

FIG. 4 is a perspective view of an alternative string trimmer embodiment of the invention illustrating the string trimming operation;

FIG. 5 is a perspective view of the string trimmer supporting handle of FIG. 4 illustrating the string edging operation;

FIG. 6 is a perspective view of an alternative blade edger embodiment of the invention illustrating the blade edging operation;

FIG. 7 is a perspective view of an alternative brush-cutter embodiment of the invention illustrating the brush-cutting operation;

FIG. 8 is a perspective view of an alternative sweeper/vac supporting handle embodiment of the invention illustrating the grounds cleanup operation;

FIG. 9 a perspective view of the alternative sweeper/vac supporting handle of FIG. 8 illustrating the grounds cleanup operation;

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Referring now to the drawings, and in particular to FIGS. 1-4, there is shown a hand-held powered grounds tool in accordance with a preferred embodiment of the invention designated at 10 generally comprising a support 12 having a power control handle 14 and a guide handle 16 mounted at an upper end portion of a support 12 by one or more fasteners 34. An electric/gas motor (not shown) is mounted in the support 16 to drive an implement 22 extending out at a use end of the support 10. A trigger 18 adjacent the power control handle 14 motions the motor to perform grounds care work at the implement 22.

In the exploded drawing of FIG. 2, each handle 14 and 16 includes a handgrip 24 and 26 extending from one or more prongs 28 to a ball joint 30. A ball socket closure 32 is sized on one side to mount over the ball joint 30 and sized on the other side to mount over the support 12. Each handle 14 and 16 is fastened to the support 12 by one or more fasteners 34, e.g., threaded screw, rivet, adhesive, clamp, clip, weld, metal band, releasable lock, etc. For example, the ball socket closure 32 can include a releasable lock 36, except when the powered grounds tool 10 demands tool adjustment with one or more threaded fasteners 38. Those threaded fasteners 38 discourage rotation of each handle 14 and 16, which is ideal for maintaining the bladed grounds tools, i.e., an edger unit 10b later shown in FIG. 6, a brush-cutter unit 10c depicted in FIG. 7, etc., in a stationary mode of operation.

As shown in FIGS. 1-3b, the releasable lock 36 can be selectively moved to a closed position 44 to secure the ball joint 30 tightly to the ball socket closure 32, which secures each handle 14 and 16 tightly to the support 12. The releasable lock 34 can also be selectively moved to an opened position 46 for rotation of each handle 14 and 16 beside the support 12 longitudinal axis, e.g., clockwise-to-counterclockwise thirty degrees, front-to-back sixty degrees and side-to-side up to two-hundred forty degrees, etc. The ball joint 30 and ball socket closure 32 interface need not be made of smooth spherical casing material but rather may include a plurality of spikes 40 and dimples 42, which interact for adding frictional control to each handle 14 and 16.

Still referring to FIGS. 1-3b, the handle 14 and 16 handgrips 24 and 26 can receive, but it is not essential, one or more wavy medium shore treads 48 intermittent to one or more rigid shore treads 50, so that there is sufficient absorption of handle vibration at each medium shore tread 48 while each handle 14 and 16 maintains its structure at each rigid shore tread 50. Preferably, a damping strip 52 has at least one or more catch openings 54 to configured to mount to one or more hooks 56 on the support 12 and or each handle 14 and 16 for damping handle vibration. Such damping strips are needed when a free end of each handle 14 and 16 telescopes a remote distance away from the implement 22.

As shown in FIGS. 1-5 a powered grounds tool 10, namely, an alternative string trimmer 10a has the supporting handles 14 and 16 grasped along the support longitudinal axis, while the trigger 18 is selectively activated by an adjoining index finger, as described in FIG. 3a, to advance a string implement 22a, e.g., small diameter automatic feed string, moderate diameter bump & feed string, large diameter fixed string, etc., in a low lateral swath direction near the ground surface during the string trimming operation 122a. The handles 14 and 16 can be adjusted beside the support 12 longitudinal axis and grasped in a predetermined low upstanding balanced position, while the trigger is selectively activated by an adjoining thumb, as described in FIG. 3b, to advance the string implement in a tall vertical swath direction from the grounds border during the string edging operation 222a. The handles 14 and 16 are designed to adjust to adjust the implement 22 sufficiently above the ground surface, in order to decrease implement-grounds chatter, tool moment arm kickback and handle vibration.

As shown in FIG. 6 an alternative blade edger 10b has the supporting handles 14 and 16 grasped along the support 12 longitudinal axis, while the trigger 18 is selectively activated by an index finger to advance a rotary knife implement 22b in a low vertical swath direction into a grounds border during the blade edging operation 222b. The blade edger 10b guide handle 14 is, but it is not essential, tool adjusted on the support 12, due to the knife 22b being prone to lateral kickback when rotatably tilted on the ground surface. In this case, one or more small threaded fasteners 38 can be loosened on each edger 10b handle 14 and 16 to adjust the edger 10b to the user's height.

As shown in FIG. 7, an alternative brush-cutter 10c has the supporting handles 14 and 16 grasped in a U-shaped pattern beside the support longitudinal axis to advance a saw blade 22c implement in a lateral swath direction during the brush cutting operation 122c. The brush-cutter 10c saw blade 22c is advances above the ground surface to prevent dulling of the saw blade 22c while clearing tree saplings, cacti, etc. Each brush cutter 10c handle 14 and 16 can be adjusted across the support 12 longitudinal axis, in order to telescope on the reverse side of the support 12. The brush cutter 10c trigger 18 can be activated by an index finger below the support 12 or a thumb above the support 12. Such alternative thumb and index finger engagement on the index finger can also be provided during the aforementioned string trimmer 10a operation. The advantage of thumb engagement on the tool 10 trigger 18 is that the underside of the power control handle 14 now has four fingered support instead of three fingered support because the finger or thumb to trigger engagement mostly floats on a spring (not shown).

As shown in FIGS. 8-9, an alternative air sweeper 10d has each handle 14 and 16 available to grasp to advance a rotary fan and pipe/nozzle implement 22d, which forces air toward detached debris to move the detached debris into the yard during the grounds cleanup operation 122d. The air sweeper/vac 10d trigger 18 is preferably mounted over the power control handle 14 for providing larger finger interaction on power control handle 14. If desired, however, the air sweeper/vac 10d trigger 18 can also be mounted below the power control handle 14 for active engagement of an index finger. The air sweeper/vac 10d power control handle can be rotated sideways to orient the fan and pipe nozzle implement in a vertical direction to sweep debris with less airborne debris during the restrained blower operation 222d. The air sweeper 10d may also include a detachable guide handle 16 to evenly distribute the air sweeper 10d reactive forces. The air sweeper/vac 10d may further include, but it is not essential, a damping strip 52 mounted near a free end of the power control handle 14 and a nearby end of the support 12. Of course, the air sweeper can have a reverse fan (not shown) to vac up fallen or raked leaves, which reduces disease inside the yard.

While the invention has been described in connection with a preferred grounds embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A powered grounds tool supporting handle comprising:
a support;
a control handle and or a guide handle including at least one ball socket closure mounted to an upper end portion of said support with one or more fasteners, said control handle and or said guide handle including one handgrip and at least one ball joint joined together by one or more prongs, in connection with a convex side of one said ball joint largely mounting in one said ball socket closure beside said support longitudinal axis, so that each said handle can be secured to said support;
a drive assembly including a motor is mounted in said support to communicate with a trigger beside said control handle to drive an implement, e.g., nylon string, knife, radial saw, fan and pipe/nozzle assembly, etc., extending out at a lower anterior use end of said support;
wherein each said handle is grasped in a predetermined tall upstanding profile to advance said implement in a low lateral profile sufficiently above the ground surface, except when said implement is used for soil penetration; and
wherein each said handle is also grasped in a predetermined low upstanding profile to advance said implement in a tall vertical profile sufficiently above the ground surface, except when said implement is used for soil-penetration;

2. The hand-held powered grounds tool according to claim 1, wherein each said handle may include a releasable lock for defining each said handle in two positions: a closed position to secure said ball joint tightly to said ball socket closure, which secures each said handle tightly to said support and an opened position for rotating each said handle beside said support longitudinal axis to either respective tall or low upstanding positions.

3. The hand-held powered grounds tool according to claim 1, wherein each said handle may exclude said releasable lock and use one or more tool adjustable fasteners, e.g. threaded fastener, metalic band clamp, etc., when the powered grounds tool requires said implement to maintain a stationary mode of operation.

4. The hand-held powered grounds tool according to claim 1, wherein each said handgrip may include a plurality of wavy medium shore tread intermittent to a plurality of wavy rigid shore treads for sufficient absorption of handle vibration at each medium shore tread while each said handle maintains its structural shape at each rigid shore tread.

5. The hand-held powered grounds tool according to claim 1, wherein a free end of each said handle and said support may include one or more hooks to retain an adjustable damping strip at one or more catch openings of said adjustable damping strip for damping handle vibration at said adjustable damping strip.

6. The hand-held powered grounds tool according to claim 1, wherein said ball joint may include a plurality of spikes configured to mostly puzzle a plurality of dimples formed in convex side of said ball socket closure for adding frictional control to each said handle.
